(19) United States
(12) Patent Application Publication
(10) Pub. No.: US 2025/0061195 A1
(43) Pub. Date: Feb. 20, 2025

(54) ARTIFICIAL INTELLIGENCE SECURITY ENGINE IN A SECURITY MANAGEMENT SYSTEM

(71) Applicant: Microsoft Technology Licensing, LLC, Redmond, WA (US)

(72) Inventor: Tamer SALMAN, Haifa (IL)

(21) Appl. No.: 18/451,405

(22) Filed: Aug. 17, 2023

(51) Int. Cl. G06F 21/55

(52) U.S. Cl. CPC G06F 21/554; G06F 21/552; G06F 2221/034

(57) ABSTRACT

Methods, systems, and computer storage media for providing security posture management using an artificial intelligence security engine in a security management system. Security posture management supports security management of a computing environment based on contextual information associated with artificial-intelligence-supported applications. The security management system provides an artificial intelligence security graph associated with the artificial-intelligence-supported applications. The artificial intelligence engine uses the artificial intelligence security graph to correlate artificial intelligence attack monitoring data with operational data of the artificial-intelligence-supported applications. In operation, artificial intelligence attack monitoring data is accessed. An artificial intelligence security graph associated with a plurality of artificial-intelligence-supported applications is accessed. Based on the artificial intelligence attack monitoring data and the artificial intelligence security graph, operational data of an artificial-intelligence-supported application is accessed. The artificial intelligence attack monitoring data and the operational data are analyzed to identify an artificial intelligence security alert. The artificial intelligence security alert is communicated.

### BACKGROUND

Users rely on computing environments with applications and services to accomplish computing tasks. Distributed computing systems host and support different types of applications and services in managed computing environments. In particular, computing environments can implement a security management system that provides security posture management functionality and supports threat protection in the computing environments. For example, data security posture management (DSPM), cloud security posture management (CSPM) and enterprise security posture management (collectively “security posture management”) can include the following: identifying and remediating risk by automating visibility, executing uninterrupted monitoring and threat detection, and providing remediation workflows to search for misconfigurations across diverse cloud computing environments and infrastructure.

### SUMMARY

Various aspects of the technology described herein are generally directed to systems, methods, and computer storage media for, among other things, providing security posture management using an artificial intelligence security engine of a security management system. Security posture management supports security management of a computing environment based on contextual information associated with artificial intelligence applications. In particular, the security management system provides an artificial intelligence security graph that models artificial-intelligence-supported applications in the computing environment. The artificial intelligence security engine uses the artificial intelligence security graph to analyze and correlate artificial intelligence attack monitoring data (e.g., anomalies or alerts) with operational data (e.g., behavioral data and communication data) of the artificial-intelligence-supported applications. The security management system can filter or classify artificial intelligence security alerts as high fidelity alerts using the correlations that are identified between the artificial intelligence attack monitoring data, the artificial intelligence security alerts, and the operational data. Based on the artificial intelligence security graph and the artificial intelligence security alerts, security posture management can be provided to support management of security aspects of data, resources, and workloads in computing environments including identifying and remediating risk.

The artificial intelligence security engine operates to provide security posture management based on generating an artificial intelligence security graph—using application data of artificial-intelligence-supported applications of a computing environment—and generating, filtering, and classifying artificial intelligence security alerts based on analyzing and correlating artificial intelligence attack monitoring data with operational data of the artificial-intelligence-supported applications. The artificial intelligence security engine operations are executed to generate the artificial intelligence graph using application data associated with artificial-intelligence-supported applications. The artificial intelligence security graph is deployed to support generating security posture information for a computing environment. For example, a security administrator can request security posture of a computing environment, and the security posture is provided based in part on the artificial intelligence security graph.

Conventionally, security management systems are not configured with a comprehensive computing logic and infrastructure to effectively generate and filter artificial intelligence security alerts in a computing environment. For example, a security management system can operate to identify malicious plugins that could be used on interfaces of artificial-intelligence-supported applications or monitor malicious or anomalous attempts to access artificial intelligence-supported applications. Such security management systems lack integration with artificial intelligence security engine operations that improve the identification of high fidelity artificial intelligence security alerts for security posture management.

A technical solution—to the limitations of conventional security management systems—can include the challenge of generating the artificial intelligence security graph and employing the artificial intelligence security graph to identify and filter artificial intelligence security alerts—and providing security management operations and interfaces via an artificial intelligence security engine in a security management system. As such, the security management system can be improved based on artificial intelligence security engine operations that operate to effectively determine and provide security posture information of a computing environment in a particular manner. In operation, artificial intelligence attack monitoring data is accessed. An artificial intelligence security graph, associated with a plurality of artificial-intelligence-supported applications, is accessed. Based on the artificial intelligence attack monitoring data and the artificial intelligence security graph, operational data of an artificial-intelligence-supported application is accessed. The artificial intelligence attacking monitoring data and the operational data are analyzed to identify an artificial intelligence security alert. The artificial intelligence security alert is communicated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an exemplary security management system that includes an artificial intelligence security engine, in accordance with aspects of the technology described herein;

FIG. 1C is a schematic associated with an exemplary security management system that includes an artificial intelligence security engine, in accordance with aspects of the technology described herein;

FIG. 2A is a block diagram of an exemplary security management system that includes an artificial intelligence security engine, in accordance with aspects of the technology described herein;

FIG. 2B is a block diagram of an exemplary security management system that includes an artificial intelligence security engine, in accordance with aspects of the technology described herein;

FIG. 3 provides a first exemplary method of providing security posture management using an artificial intelligence security engine, in accordance with aspects of the technology described herein;

FIG. 4 provides a second exemplary method of providing security posture management using an artificial intelligence security engine, in accordance with aspects of the technology described herein;

FIG. 5 provides a third exemplary method of providing security posture management using an artificial intelligence security engine, in accordance with aspects of the technology described herein;

FIG. 6 provides a block diagram of an exemplary distributed computing environment suitable for use in implementing aspects of the technology described herein; and

FIG. 7 is a block diagram of an exemplary computing environment suitable for use in implementing aspects of the technology described herein.

### DETAILED DESCRIPTION

### Overview

A security management system supports management of security aspects of data, resources, and workloads in computing environments. The security management system can help enable protection against threats, help reduce risk across different types of computing environments, and help strengthen a security posture of computing environments (i.e., security status and remediation action recommendations for computing resources including networks and devices). For example, the security management system can provide real-time security alerts, centralize insights for different resources, and provide for preventative protection, post-breach detection, and automated investigation, and response. The security management system can further support providing security posture management with security management operations (e.g., security investigation queries) that support identifying potential threats and actual threats.

Conventionally, security management systems are not configured with a comprehensive computing logic and infrastructure to effectively generate and filter artificial intelligence security alerts data in a computing environment. For example, a security management system can operate to identify malicious plugins that could be used on interfaces of artificial-intelligence-supported applications or monitor malicious or anomalous attempts to access artificial intelligence-supported applications. Such security management systems lack integration with artificial intelligence security engine operations that improve the identification of high fidelity artificial intelligence security alerts for security posture management.

Merely monitoring communications at interfaces associated with artificial-intelligence-supported applications—to identify attacks on artificial intelligence applications—is insufficient. For example, an application that is supported by generative artificial intelligence services can still be compromised if a security system operates only to identify classic pitfalls—(e.g., unusual outbound network traffic; anomalies in privileged user account activity; or geographical irregularities)—based on metadata, or listening to conversations at a generative artificial intelligence prompt. Moreover, without an adequate security solution, the resulting security alerts can include a significant amount of noise and investigating security alerts in a computing environment can be tedious and inefficient; and potential threats can become actual threats which can lead to unauthorized access to data and malicious operations in the computing environment. As such, a more comprehensive security management system—with an alternative basis for performing security management operations—can improve computing operations and interfaces for securing management.

Embodiments of the present technical solution are directed to systems, methods, and computer storage media, for among other things, providing security posture management using an artificial intelligence security engine of a security management system. Security posture management supports security management of a computing environment based on contextual information associated with artificial intelligence applications. In particular, the security management system provides an artificial intelligence security graph that models the artificial-intelligence-supported applications in the computing environment. The artificial intelligence security engine uses the artificial intelligence security graph to analyze and correlate artificial intelligence attack monitoring data (e.g., anomalies or alerts) with operational data (e.g., behavioral data and communication data) of the artificial-intelligence-supported applications. The security management system can filter or classify artificial intelligence security alerts as high fidelity alerts using the correlations that are identified between the artificial intelligence attack monitoring data, the artificial intelligence security alerts, and the operational data. Based on the artificial intelligence security graph and the artificial intelligence security alerts, security posture management can be provided to support management of security aspects of data, resources, and workloads in computing environments including identifying and remediating risk. Security posture management is provided using the artificial intelligence security engine that is operationally integrated into the security management system. The security management system supports an artificial intelligence security engine framework of computing components associated with artificial intelligence security graph comprising contextual information of artificial-intelligence-supported applications for determining a security posture of a computing environment.

At a high level, a security management system is provided with an artificial intelligence security engine that implements an artificial intelligence security graph. The security management system curates contextual information related to artificial-intelligence-supported applications and connects the contextual information to the artificial intelligence security graph (i.e., a contextual security graph). The artificial intelligence security graph can be used to provide a unified security posture and threat protection for a computing environment. For example, based on the artificial intelligence security graph and connections a measure of an impact of risk of an artificial-intelligence-supported application can be quantified and mitigation actions can be prioritized. In addition, contextual correlations of anomalies and artificial intelligence security alerts can be determine to surface high fidelity artificial intelligence security alerts. Moreover risk assessment can include understanding relationships in artificial intelligence security graph via contextual information and reducing attack surfaces—i.e., possible points (e.g., network interfaces, web applications, APIs and integrations, and user accounts) through which an attacker can potentially target or compromise the computing environment.

By way of context, a computing environment can implement artificial intelligence systems that are used to accomplish different types of computing tasks. The artificial intelligence systems can be used to generate new content, create models, or produce creative outputs. In particular, the artificial intelligence systems can support generative artificial intelligence techniques that focus on producing data or content instead of analyzing existing data. The generative artificial intelligence services can be related to content creation, design and creativity, media production, simulation and virtual worlds, data augmentation, personalization and scientific discovery. The artificial intelligence systems can implement artificial intelligence models that are associated with artificial intelligence applications that support other applications (i.e., artificial-intelligence-supported applications) in a computing environment. An artificial intelligence application can include an interface (e.g., user interface or programming interface) that allows developers, users, or applications to interact with and utilize artificial intelligence models (e.g., generative AI models) and capabilities. Interfaces for artificial intelligence applications can be associated with input interaction, model interaction, output display, customization and parameters, integration, and feedback loop.

Artificial intelligence systems and their interfaces can be susceptible to different types of cyberattacks relative to traditional computing systems. In particular, the interfaces of artificial intelligence system can go beyond traditional human-computer interactions and provide users and developers with AI-generated outputs, responses and experiences. These interfaces can be dynamic, creative, and support personalized interactions; however, may further expose the artificial intelligence systems and the corresponding computing environment (i.e., artificial-intelligence-supported applications) to cyberattacks. These cyberattacks may specifically exploit the capabilities of generative AI models to cause harm and deceptions. In this way, while generative AI can be powerful tool for creating content and enhancing user experiences, it also introduces new attack vectors and security challenges (e.g., deep fake attacks, AI-enhanced phishing, malicious content generation, evasion of security measures, AI-driven social engineering, AI-supported identity theft, AI-powered DDOS attacks).

The artificial intelligence security engine supports analyzing and modeling connections between artificial-intelligence-supported applications in a computing environment in an artificial intelligence security graph. The artificial intelligence security engine can gather application data (e.g., identity data, configuration data, code data) of artificial-intelligence-supported applications to generate the artificial intelligence security graph. The artificial intelligence security graph is a model of artificial-intelligence-supported applications their corresponding connections with computing components in a computing environment. The artificial intelligence security graph can be generated using application data associated with applications and computing components in the computing environment. The artificial intelligence security graph can be generated using an artificial intelligence security graph generation model that includes programmable instructions of how to generate the artificial intelligence security graph. The artificial intelligence security graph generation model can identify designated input and combination of operations used to generate an artificial intelligence security graph.

The artificial intelligence security graph may be generated as a multi-layer security graph. The layers of the multi-layer security graph can be associated with varying levels of automation and having varying levels of engineering and algorithm complexities. By way of illustration, a first layer can be associated with graph edges (e.g., controls, identities, and tags) that are added in an automated manner—thus having low friction and low complexity; a second layer can be associated with edges that are added manually, the edges are associated with artificial-intelligence-supported application—thus having high friction but low complexity; a third layer can be associated with code and behavior analysis of artificial intelligence-supported application can be used to augment connections—thus having low friction and high complexity.

The artificial intelligence security graph may include, by way of example, users/identities that have access to or that access artificial-intelligence-supported applications; user/identities that an artificial intelligence application impersonates or works on behalf of; processes of artificial-intelligence-supported applications; data stores of artificial-intelligence-supported applications including their permissions to access, read, and write. Moreover, additional connections can be made based on analysis of code of artificial-intelligence-supported applications and code repositories to identify connections associated with artificial-intelligence-supported applications.

The artificial intelligence security graph is generated based on the application data to include a plurality of connections between artificial-intelligence-supported applications. Based on the modeled connections, contextual information associated with the artificial-intelligence-supported applications can be used to provide improved security posture management. The artificial intelligence security graph can support understanding an impact of compromising the artificial-intelligence-supported applications—including what data a particular compromised artificial-intelligence-supported application has access to, users that are exposed to by a compromised artificial-intelligence-supported application, what security measures need to be taken to secure the artificial-intelligence-supported applications. Moreover, the artificial intelligence security graph can support creating high fidelity artificial intelligence security alerts and incidents based on correlating anomalous and suspicious behaviors monitored on usage of artificial-intelligence-supported applications with suspicious behaviors and other indications of compromise of the related applications, data store, identities that are impersonated, etc.

In this way, the artificial intelligence security engine operates using a contextual security framework that includes environmental awareness of a targeted computing environment. Conventional solutions result in noisy artificial intelligence security alerts, which can be addressed by implementing the contextual security framework that supports improved security decision-making and identification of artificial intelligence security alerts with high fidelity. The contextual security framework facilitates answering what applications need to be secured; how can the attack surface of these applications be reduced; and how to detect and respond to attacks on theses application. The contextual security framework facilitates understanding exposure of applications; potential impact of compromises; and provides indicators of compromised applications to help detect attack on the applications.

The artificial intelligence security engine analyzes and correlates artificial intelligence attack monitoring data, artificial intelligence security alerts, and operational data to provide security posture management. Artificial intelligence attack monitoring data can refer to data that is monitored for determining cyberattacks associated with artificial-intelligence-supported applications. For example, artificial intelligence attack monitoring data can be associated with cyberattack constructs including unusual outbound network traffic, anomalies in privileged user account activity, or geographical irregularities. In particular, artificial intelligence attack monitoring data can include various inputs and outputs that are tracked for artificial intelligence models (e.g., generative AI models) to identify potential attack, detect anomalies, ensuring security and integrity of AI-generated content. Artificial intelligence attack monitoring data can be associated with interfaces that connect AI models to applications in a computing environment, where the interface between the AI models (e.g., large language models) and the application supports artificial intelligence assistant features (e.g., MICROSOFT CO-PILOT) for the application. The artificial intelligence attack monitoring data can be based on model inputs, model outputs, model behavior, model training and updates, user behavior, context verification, and anomaly detection.

The artificial intelligence security engine may also generate preliminary artificial intelligence security alerts which can be further analyzed, filtered, or classified using the artificial intelligence security graph. For example, based on the artificial intelligence attacking monitoring data an artificial intelligence security alert can be generated and then analyzed using features and functionality associated with the artificial intelligence security graph. The artificial intelligence security alert can indicate potential security incidents or events that require attention with security posture information including source and destination of an event, timestamp of the event, severity level, alert type, description, reference identifier, affected system or source, user or identity accounts, recommendations, additional data, etc. The artificial intelligence alert security posture information can be analyzed using the artificial intelligence security graph and operational data.

Operational data can refer to data that is collected for artificial-intelligence-supported applications and computing components to support making correlations with artificial intelligence attack monitoring data or preliminary artificial intelligence security alerts. Operational data is associated with monitoring the artificial-intelligence-supported applications for detecting issues, anomalies, troubleshooting problems and implementing security. Operational data can include server logs and performance metrics, network traffic and bandwidth usage, security logs and access control data, database usage and performance statistics, application uptime and response times, and backup and recovery status. Operational data can be stored as nodes or edges associated with the artificial-intelligence-supported application in the artificial intelligence security graph. Operational data can further include security posture information associated with artificial-intelligence-supported application that is stored at least in part in the artificial intelligence security graph. Operational data can specifically include security log data include recorded information that captures activities, events, and incidents related to security of the artificial-intelligence-supported application.

Analyzing the artificial intelligence attack monitoring data, artificial intelligence security alerts, and operational data is based on artificial intelligence security operations that support correlating two or more of artificial intelligence attack monitoring data, artificial intelligence security alerts, and operational data for patterns that indicate that the data changes together. For example, the artificial intelligence security engine can implement machine learning techniques and statistical methods for analyzing correlation between variables or features of the artificial intelligence attack monitoring data, artificial intelligence security alerts, and operational data. Machine learning techniques and statistical methods can include clustering algorithms, time series analysis, principal component analysis, and correlation matrix. Based on the analysis, inferences can be made about artificial intelligence security alerts. For example, a high correlation score between features of the artificial intelligence attack monitoring data and operational data can indicate a high fidelity signal of an artificial intelligence security alert and a low correlation score between features of the artificial intelligence attack monitoring data and operational data can indicate a low fidelity signal of an artificial intelligence security alert. A high correlation can be found where an anomalous prompt at a generative AI application prompt triggers communications from a database that should not communicate with the generative AI prompt; detecting this type of correlation is facilitated via the artificial intelligence security graph.

Advantageously, the embodiments of the present technical solution include several inventive features (e.g., operations, systems, engines, and components) associated with a security management system having an artificial intelligence security engine. The artificial intelligence security engine supports artificial intelligence security engine operations used to generate the artificial intelligence security graph and employing the artificial intelligence security graph to identify artificial intelligence security alerts—and providing security management operations and interfaces via an artificial intelligence security engine in a security management system. The artificial intelligence security engine operations are a solution to a specific problem (e.g., limitations in effective identification of artificial intelligence security alerts) in security management. The artificial intelligence security engine provides ordered combination of operations for generating and deploying an artificial intelligence security graph and using the artificial intelligence security graph in a way that improves computing operations in a security management system. Moreover, large amounts of artificial intelligence security alerts can be processed and filtered to provide security posture information for applications in a particular manner that improves user interfaces of the security management system.

### Example Systems and Operations

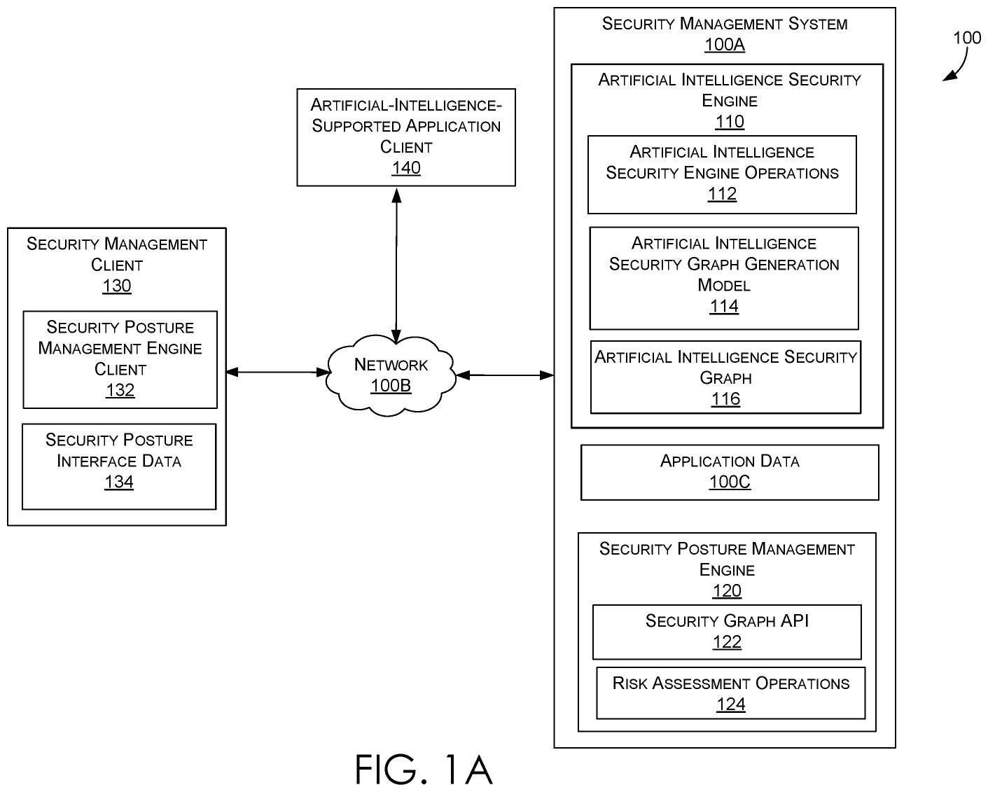

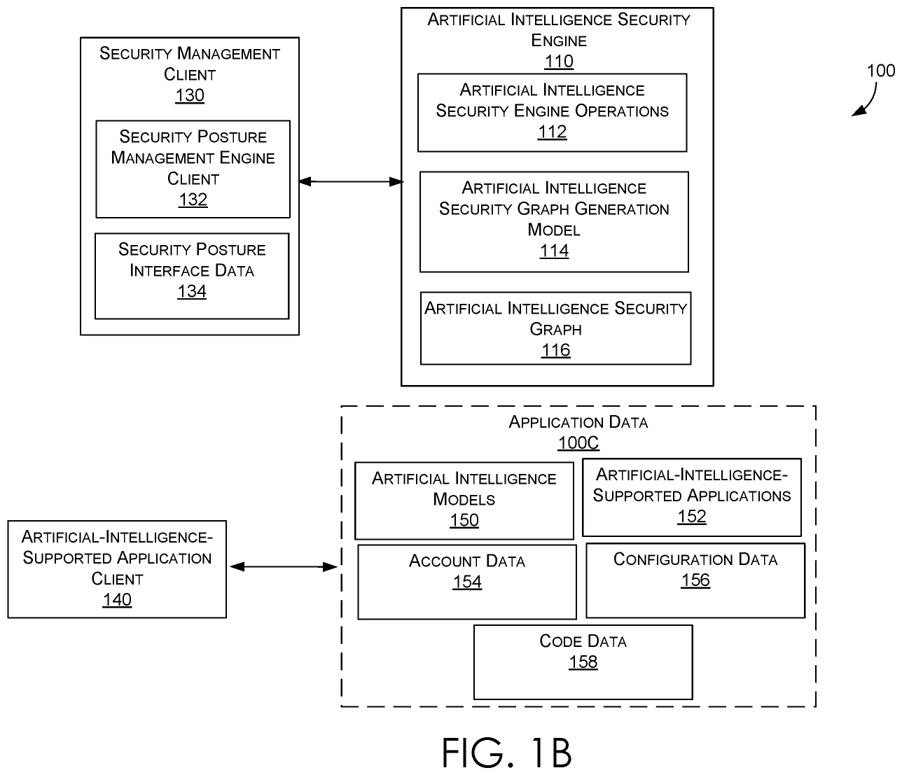

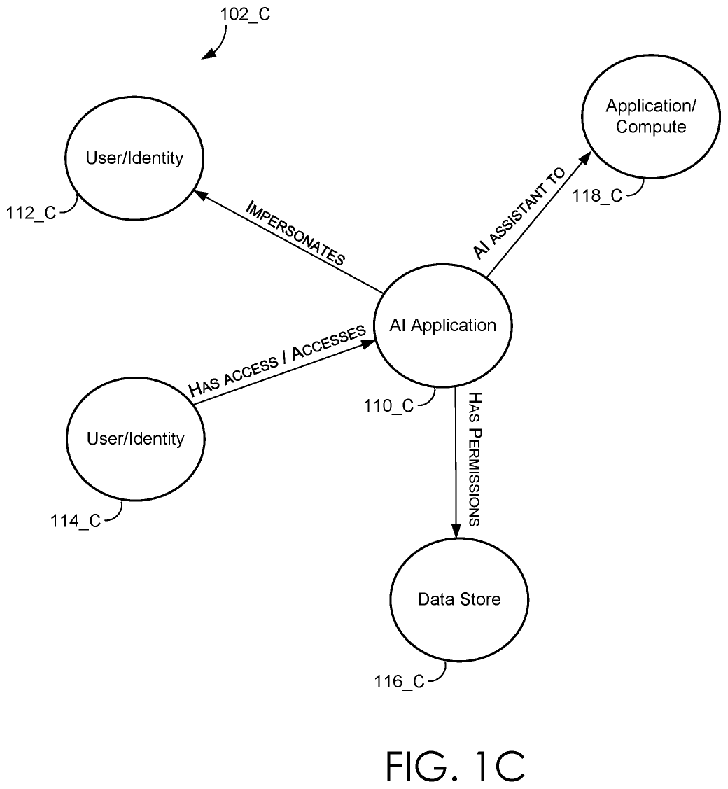

Aspects of the technical solution can be described by way of examples and with reference to FIGS. 1A-1B. FIG. 1A illustrates a cloud computing system (environment) 100 including security management system 100A; network 100B; application data 100C; artificial intelligence security engine 110 having artificial intelligence security engine operations 112, artificial intelligence security generation model 114, artificial intelligence security graph 116; security posture management engine 120 with security graph API 122 and risk assessment operations 124, and security management client 130 with security posture management engine client 132 and security posture interface data 134; and artificial-intelligence-supported application client 140.

The cloud computing environment 100 provides computing system resources for different types of managed computing environments. For example, the cloud computing environment 100 supports delivery of computing services—including servers, storage, databases, networking, and security intelligence. A plurality of security management clients (e.g., security management client 130) include hardware or software that access resources in the cloud computing environment 100.

Security management client 130 can include an application or service that supports client-side functionality associated with cloud computing environment 100. The plurality of security management clients can access computing components of the cloud computing environment 100 via a network (e.g., network 100B) to perform computing operations. The artificial-intelligence-supported application client 140 can include an application or service that supports client-side functionality associated with the cloud computing environment. The artificial-intelligence-supported application client 140 can provide an interface of an artificial intelligence application that operates with artificial-intelligence-supported applications in the cloud computing environment. Operations from the artificial-intelligence-supported application client may include cyberattack operations that can be identified in an artificial intelligence security alert.

The security management system 100A is designed to provide security management using the artificial intelligence security engine 110. The security management system 100A provides an integrated operating environment based on a security management framework of computing components associated with providing the artificial intelligence security graph 116 using the artificial intelligence security engine 110, the artificial intelligence security graph generation model, and application data 100C. The security management system 100A integrates artificial intelligence security engine operations—that support generating the artificial intelligence security graph and employing the artificial intelligence security graph 116 to identify artificial intelligence security alerts—into security management operations and interfaces to effectively provide security posture investigation information, security posture information, and remediation information for a computing environment. For example, a security administrator can request security posture information of a computing environment, and the security posture information is provided based in part based on the artificial intelligence security graph 116.

The artificial intelligence security engine 110 is responsible for generating the artificial intelligence security graph 116 based on application data 100C, artificial intelligence security engine operations 112, and artificial intelligence security graph generation model 114. The artificial intelligence security graph generation model 114 is a computational model that support generating the artificial intelligence security graph 116. The computational model includes instructions of different data types and rules for integrating the data types to generate the artificial intelligence security graph 116. The artificial intelligence security graph generation model 114 supports accessing application data 110C to generate artificial intelligence security graph as a model of artificial-intelligence-supported applications and their connections in a computing environment. The computational model supports programmatically constructing and deriving connections based on application data for one or more layers of the artificial intelligence security graph.

The artificial intelligence security graph generation model 114 can specifically support generating the artificial intelligence security graph 116 as a multi-layer security graph. The artificial intelligence security graph generation model 114 can include different layers associated with varying levels of automation and varying level engineering and algorithm complexity. As such, each layer can be associated with a friction identifier and complexity identifier (e.g., low, medium, and high) that are factors associated with efficiency, effectiveness, and user experience in supporting the generation of the artificial intelligence security graph 116. In this way, artificial intelligence security graph generation model 114 can include instructions on graph edges (e.g., controls, identities, tags, etc.) that are automatically added to the artificial intelligence security graph 116, graph edges (e.g., scope of artificial intelligence applications) that are manually added to the artificial intelligence security graph, and how to use code and code repositories to augment connections between the artificial intelligence application and other nodes (e.g., identities, data stores, and artificial-intelligence-supported applications) in the computing environment.

The artificial intelligence security engine 110 accesses application data 100C from a plurality of data sources. The data sources can include cloud storage, databases, cloud applications, streaming data, service application and external data sources associated with security posture management. The application data 100C can specifically include artificial intelligence models, artificial-intelligence-supported applications, identity data, configuration data, and code data. The application data 100C can be graphically represented in the artificial intelligence security graph 116. The application data 100C can be security log data including recorded information that captures activities, events, and incidents related to security in a computing environment. Security log data can further include data retrieved via the security graph API 122. Security log data can support providing a detailed audit trail and evidence of security-related events for monitoring, analysis and investigation purposes. Security log data can be associated with authentication events, authorization events, system events, intrusion detection/prevention systems (IDS/IPS), firewall logs, antivirus/antimalware logs; SIEM logs, audit logs, and security incident logs. The data sources support retrieving application data 100C that are associated with different data types that are defined in the artificial intelligence security graph 116. The data sources are associated with a plurality of computing resources (e.g., virtual machines, storage, databases, tenant, content delivery network, containers, monitoring and analytics, development). The artificial intelligence security engine 110 can further include an application data 100C API (not shown) that supports retrieving different types of application data 100C to generate artificial intelligence security graph 116. The artificial intelligence security engine 110 deploys the artificial intelligence security graph 116 to support generating security posture information for a computing environment.

The security posture management engine 120 is responsible for communicating with a security management client 130 having the security posture management engine client 132 and the security incident interface data 134. The security posture management engine client 132 supports client-side security management operations for providing security management in the security management system 100. The security posture management engine client 132 supports presenting a security posture visualization—including artificial intelligence security alerts—associated with the artificial intelligence security graph 116, and communicating an indication to perform a remediation action associated with artificial intelligence security alerts. As such, the security incident interface data 134 can include data associated with the artificial intelligence security engine 110, and data associated with the security posture management 120 which can be communicated between the artificial intelligence security engine 110, the security posture management engine 120, and the security management client 130.

The security posture management engine 120 operates to provide visibility to security status of resources in a computing environment. Security posture information can be associated with artificial intelligence security graph 116, network, data, and identity resources of a computing environment. Security posture information can include artificial intelligence security alerts and artificial intelligence security alerts with updated prioritization identifiers as described herein.

The security posture management engine 120 includes a security graph API 122 that provides access to a security graph (not shown) and security graph data. The security graph provides telemetry data associated with a plurality of resources in a computing environment. In particular, the telemetry data can be security data that is associated with security providers in a computing environment. The security graph and security graph API 122 can support integrating security alerts from different security providers via an API connector that streams alerts to the security posture management engine 120. For example, the artificial intelligence security engine 110 can operate as a security provider for the security posture management engine 120.

The security posture management engine 120 may assess threats and develop risk scores—using risk assessment operations 124 including attack path analysis—associated with threats and attack paths. An attack path analysis can refer to a graph-based algorithm that scans a cloud security graph to identify exploitable paths including attack surfaces that attackers may use to breach a computing environment. The attack path analysis exposes attack paths and suggests remediation actions for issues that would break the attack path and prevent a successful breach. In this way, the attack path analysis help address security issues that pose immediate threat with the greatest potential of being exploited in a computing environment. Other variations and combinations of risk assessment operations are contemplated with embodiments of the present disclosure.

A risk associated with query results (e.g., artificial intelligence security alert) can used to generate security posture information. In particular, a risk score can refer to a numerical value that represents the level of risk associated with a particular security incident associated with the artificial intelligence security alert. It takes into account various factors such as the likelihood of the event occurring and the potential impact of the event if it does occur. The risk score is used to prioritize actions and allocate resources accordingly. In addition, the likelihood or the impact of the security threat as quantified in a risk score can be based on a number of potential attack surfaces associated with the security threat.

The security posture management engine 120 can further support generating security posture visualizations based on the security posture information including artificial intelligence security alerts and artificial intelligence security alerts with updated prioritization identifiers associated with the artificial intelligence security graph 116. Security posture information can include query results, which can be provided in combination with attack path analysis, alerts, and other security management information. For example, a security posture visualization can include query results associated with artificial intelligence security alerts and the artificial intelligence security graph 116. The security posture information can be generated based on artificial intelligence security alerts such that security posture information is prioritized and filtered. A prioritization identifier (e.g., high, medium, low) can be provided for an artificial intelligence security alert in the security posture visualization. The prioritization identifier can specifically include a prioritization identifier that is provided or updated based on analyzing an artificial intelligence security alert using artificial intelligence attack monitored data and the artificial intelligence security graph. Alternatively, a notification associated with the security management information, security prioritization information or the alert can be communicated. Other variations and combinations of communications associated with the unsecured credential are contemplated with embodiments described herein.

The security management client 130 can support accessing a security posture visualization and causing display of the security posture visualization. The security management client 130 can include the security posture management engine client 132 that supports receiving the security posture interface data 134 from the security management system 110A and causing presentation of the security posture interface data 134. The security posture interface data 134 can specifically include security posture visualizations associated with artificial intelligence security alerts. The secure posture visualization can further include remediation actions associated with different artificial intelligence security alerts—including artificial intelligence security alerts that are associated with the query results.

The security management client 130 can further support executing a remediation action. In particular, the security posture visualization can include a remediation action for an artificial intelligence security alerts or artificial intelligence security alert with an updated prioritization identifier. The security management client 130 can receive an indication to perform the remediation action associated with query results. Based on receiving the indication to execute the remediation action, the security management client 130 can communicate the indication to execute the remediation action to cause execution of the remediation action.

As such, artificial intelligence security alerts and related security posture information are generated based on the artificial intelligence security engine 110 and provided with remediation actions that can be selected and communicated to cause the remediation action to be performed. The remediation action can address an actual threat or potential threat associated with the artificial intelligence security alerts. For example, a remediation action can include off-boarding a computing device, disabling a user, quarantining a file; turning off external email, or running an antivirus scan. Other variations and combinations of security posture visualizations with the artificial intelligence security graph 114 are contemplated with embodiments described herein.

With reference to FIG. 1B, FIG. 1B illustrates artificial intelligence security engine 110—having artificial intelligence security engine operations 112, artificial intelligence security graph generation model 114, artificial intelligence security graph 116, and application data 110C including artificial intelligence models 150, artificial-intelligence-supported applications 152, account data 154, configuration data 156, and code data 158.

The artificial intelligence security engine 110 provides an artificial intelligence graph generation model 114 as a computational model that supports generating the artificial intelligence security graph 116. The artificial intelligence security graph generation model 114 can be associated with operations that are executed to generate the artificial intelligence security graph 116. The computational model is configured to provide instructions on application data 100C that is processed to generate the artificial intelligence security graph 116 as a model of artificial-intelligence-supported applications for generating and filtering artificial intelligence security alerts. The computational model supports programmatically accessing and processing application data 100C. The computational model can also support different artificial intelligence graph entity types and layers for representing artificial-intelligence-supported applications of a computing environment.

The artificial intelligence security engine 110 generates the artificial intelligence security graph 116 based on the artificial intelligence security graph generation model 114 and the application data 100C. The artificial intelligence models 150 can refer to machine learning models associated with artificial-intelligence-supported applications 152, where the artificial intelligence models 150 provide assistive functionality (e.g., via an artificial intelligence application and interface). Account data 154 can refer to user or identities that have access to or access artificial-intelligence applications associated with artificial intelligence models 150. Configuration data for an application can include parameters, settings, and options that determine how the application behaves and interacts with the computing environment. Configuration data can be external to the application's code and is used to customize the application's behavior to suit different needs, environments, and user preferences without the need for code changes. Configuration data may further allow applications to be flexible and adaptable without requiring recompilation or code modifications. Code data can refer to source code or programming code including human-readable instructions that programmers write to create application. Code data can specifically identify data structures, control structures, functions and methods with security implications that can be leverages for generating the artificial intelligence security graph and for making correlations for generating and filtering artificial intelligence security alerts.

The artificial intelligence security graph generation model designates input used to generate the artificial intelligence security graph 116. The artificial intelligence security graph may be generated as a multi-layer security graph. The layers of the multi-layer security graph can be associated with varying levels of automation and having varying levels of engineering and algorithm complexities. By way of illustration, a first layer can be associated with graph edges (e.g., controls, identities, and tags) that are added in an automated manner—thus having low friction and low complexity; a second layer can be associated with edges that are added manually, the edges are associated with artificial-intelligence-supported application—thus having high friction but low complexity; a third layer can be associated with code and behavior analysis of artificial intelligence-supported application can be used to augment connections—thus having low friction and high complexity.

With reference to FIG. 1C, FIG. 1C illustrates a schematic associated with the artificial intelligence security engine 110 in the security management system 100A. FIG. 1C is a schematic representation 102_C of an artificial intelligence security graph that models connections of an artificial intelligence application in a computing environment. FIG. 1C includes an AI application 110_C, user/identity 112_C, user/identity 114_C, data store 116_C, and application/compute 118_C. The AI application 110_C can be a generative AI application (e.g., MICROSOFT CO-PILOT) with an interface that supports different types of functionality and applications (e.g., artificial-intelligence-supported applications). The AI application 110_C can impersonate user/identity 112_C. User/identity 114_C can access the AI application 110_C or have access to user/identity 114C. AI application 110C can have permissions to data store 116C. AI application 110_C can be an AI assistant to application/compute 118_C. As such, application data can be gathered, and based on the artificial intelligence security graph generation model, the artificial intelligence security graph is generated to support providing security posture management.

By way of illustration, a generative artificial intelligence application (e.g., artificial intelligence assistive application or artificial intelligence model) impersonates and identity, assists with processes and applications, has permissions to access data, and has a user that can access the generative artificial intelligence application. The risk of a compromise of the generative artificial intelligence application can be the accumulation of risks of all the related entities and workloads. If the data is important, then the risk is high; and if the users are privileged, then the risk is high too. An attack on the generative artificial intelligence application is an attack on the users, as such, the artificial intelligence security graph can be used to make risk assessments and prioritize artificial intelligence security alerts based information—including connections between computing components and constructs that are identified in the artificial intelligence security graph. Moreover, the generative artificial intelligence application impersonates a user, the generative artificial intelligence application has access to a data store, or applications are assisted by the generative artificial intelligence application. As such, a suspicious activity can be expected to manifest suspicious behavior on one or more related entities or workloads. Correlating the various indicators of compromise supports increasing a fidelity of suspicion (e.g., an anomalous conversation and anomalous behavior in access logs).

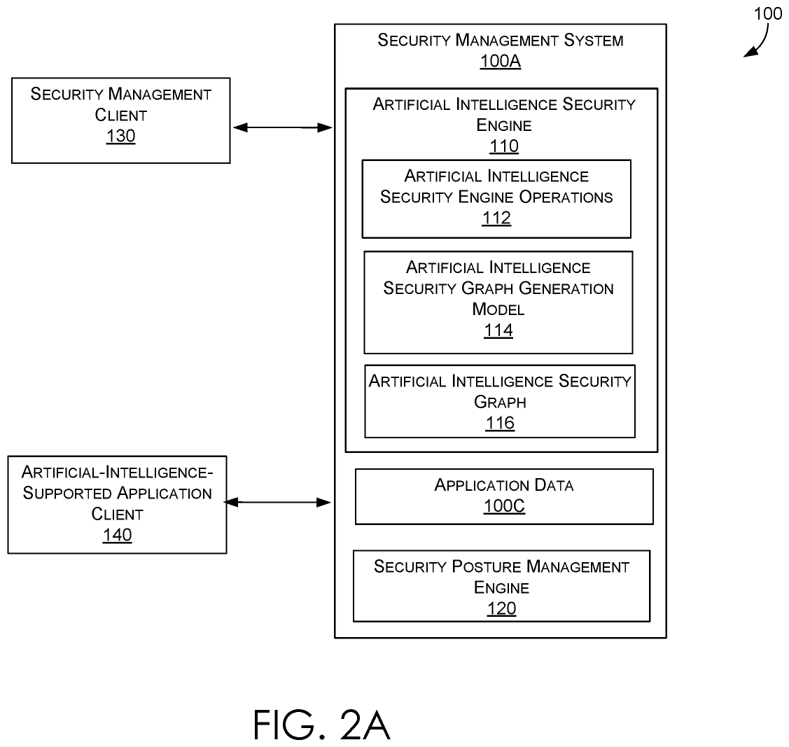

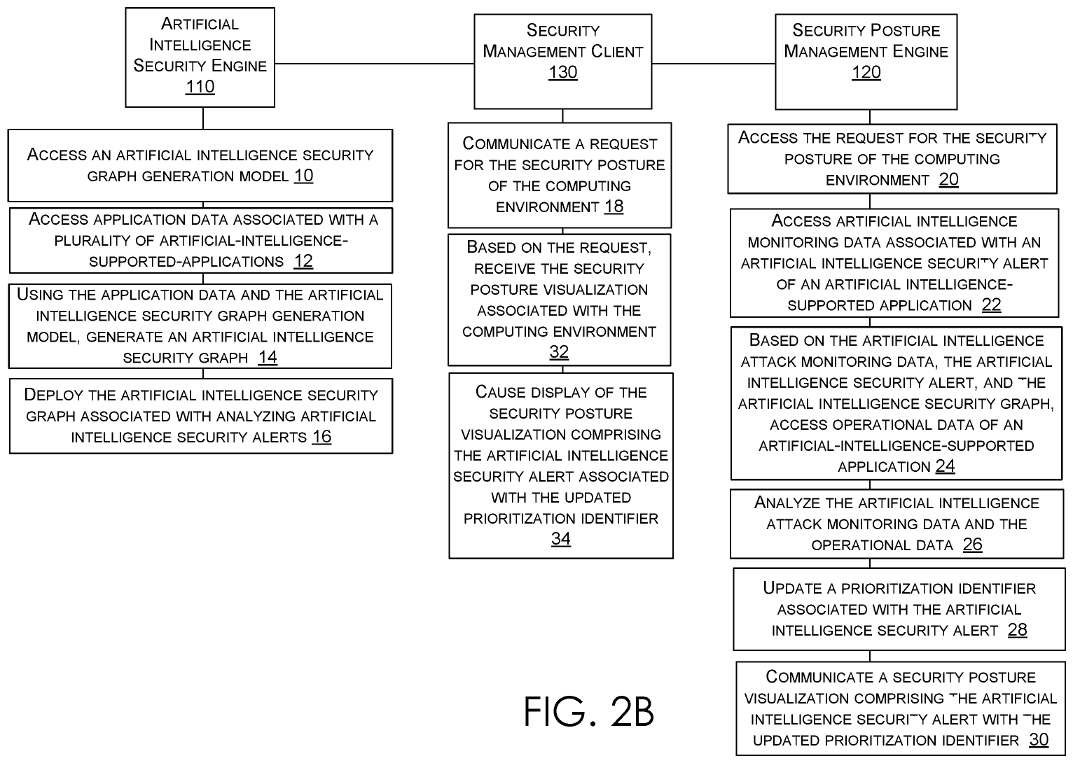

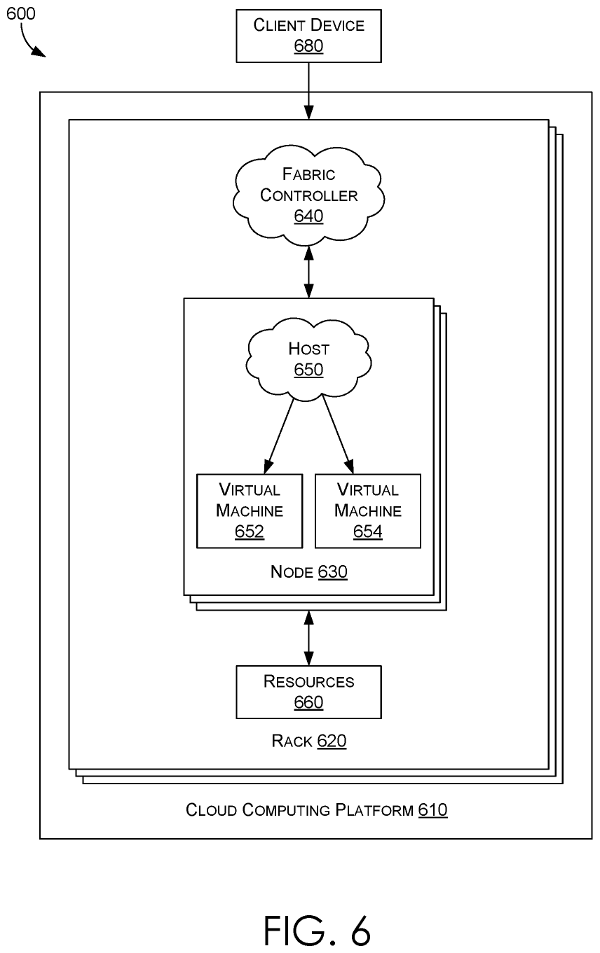

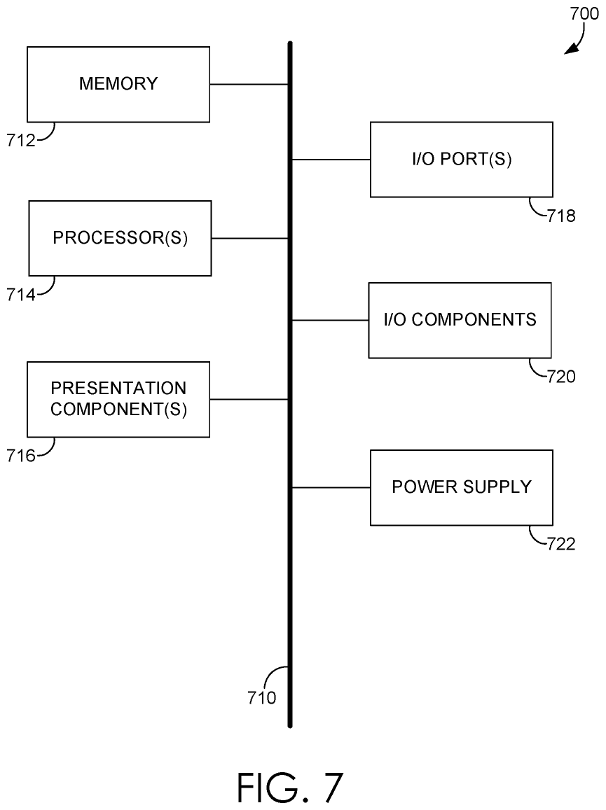

Aspects of the technical solution can be described by way of examples and with reference to FIGS. 2A and 2B. FIG. 2A is a block diagram of an exemplary technical solution environment, based on example environments described with reference to FIGS. 6 and 7 for use in implementing embodiments of the technical solution are shown. Generally the technical solution environment includes a technical solution system suitable for providing the example security management system 100 in which methods of the present disclosure may be employed. In particular, FIG. 2A shows a high level architecture of the security management system 100A in accordance with implementations of the present disclosure. Among other engines, managers, generators, selectors, or components not shown (collectively referred to herein as “components”), the technical solution environment of security management system 100 corresponds to FIG. 1A and 1B.

With reference to FIG. 2A, FIG. 2A illustrates a security management system 100A having security management system 100A, artificial intelligence security engine 110 including artificial intelligence security engine operations 112, artificial intelligence security graph generation model 114, artificial intelligence security graph 116, and application data 100C; security posture management engine 120, security management client 130, and artificial-intelligence-supported application client 140.

The artificial intelligence security engine 110 is responsible for deploying the artificial intelligence graph 116 to support generating and analyzing artificial intelligence security alerts. The artificial intelligence security engine 110 accesses the artificial intelligence generation model 114 that provides instructions on how to generate the artificial intelligence security graph. The artificial intelligence security graph generation model 114 is a model of a plurality of artificial-intelligence-supported applications in a computing environment. The artificial intelligence security engine 110 accesses data (e.g., application data 100C) associated with the plurality of artificial-intelligence-supported applications. The artificial intelligence security engine 110 uses the application data 100C and the artificial intelligence security graph generation model 114 to generate the artificial intelligence security graph 116.

Generating the artificial intelligence security graph can be based on instructions associated with the artificial intelligence generation model 114. The artificial intelligence generation model 114 can specifically support generating a multi-layer security graph. For example, generating the artificial intelligence security graph can further include one or more layers of the artificial intelligence security graph, including: generating a first layer of the artificial intelligence security graph based on a first set of application data from the application data, where the first set of application data comprises account-based connections between an artificial-intelligence-supported application and an artificial intelligence application; generating a second layer of the artificial intelligence security graph based on a second set of application data from the application data, where the second set application data comprises configuration-based connections between the artificial-intelligence-supported application and an artificial intelligence application; and generating a third layer of artificial intelligence security graph based on a third set of application data from the application data, where the third set of application data comprises code-based connections between the artificial-intelligence-supported application and an artificial intelligence application.

The artificial intelligence security engine 110 is responsible for communicating artificial intelligence security alerts. The artificial intelligence security engine 110 accesses artificial intelligence attack monitoring data. The artificial intelligence attack monitoring data can include anomalous model input data and anomalous model output data from an interface of an artificial intelligence application. The artificial intelligence attack monitoring data can specifically be associated with cyberattack that exploit artificial intelligence applications and interfaces (e.g., adversarial attacks, data poisoning, evasion attacks, model inversion attacks, privacy violations, denial of service attacks, impersonation attacks, semantic attacks, and model extraction attacks).

The artificial intelligence attack monitoring data can be continuously monitored for anomalies or alerts that trigger further investigation to determine an actual or potential attack associated with an artificial-intelligence-supported application.

The artificial intelligence attack monitoring data can be accessed from application data 100C from a plurality of sources that support monitoring for security posture management. The artificial intelligence attack monitoring data can be associated with artificial-intelligence-supported application client 130 that accesses an artificial-intelligence-supported application that is supported by the artificial intelligence application. The artificial-intelligence-supported application client 130 can be associated with a cyberattack such that the artificial intelligence attack monitoring data is associated with anomalies or alerts, and the application data (e.g., application data 110C) associated with the artificial-intelligence-supported application is also associated with anomalies or alerts.

The artificial intelligence security engine 100 accesses the artificial intelligence security graph 116. Based on the artificial intelligence attack monitoring data and the artificial intelligence security graph, artificial intelligence security engine 110 accesses operational data of an artificial-intelligence-supported application. The artificial intelligence attack monitoring data may be associated with an anomaly or alert, such that, the artificial intelligence security graph 116 is accessed to identify additional information associated with the anomaly or alert.

The artificial intelligence security engine 110 analyzes the artificial intelligence attack monitoring data and the operational data. The artificial intelligence security engine determines correlations between the artificial intelligence attack monitoring data and the operational data to make an inference that artificial intelligence security alert should be generated. For example, a correlation score can be computed to quantify a likelihood that a set of data indicates an artificial intelligence security alert, or quantity a prioritization of an artificial intelligence security alert. By way of example, an analysis can be done on historical artificial intelligence security alerts and their corresponding data. Based on the analysis, new sets of data can be evaluated and assigned correlation scores associated with their likely security risk on a computing environment.

In addition, a risk score can be calculated based on a likelihood or impact of a security threat (e.g., an actual threat or a potential threat) associated with an artificial intelligence security alert and corresponding additional factors associated with the artificial intelligence security graph. In this way, a risk score is a calculated number (score) that reflects the severity of a risk due to some factors. Risk scores are calculated by multiplying probability (e.g., probability score) and impact (e.g., impact score)—though other factors, such as weighting may be also be part of calculation. For qualitative risk assessment, risk scores can be calculated using factors based on ranges in probability and impact. In quantitative risk assessments, risk probability and impact inputs can be discrete values or statistical distributions. For example, if an artificial-intelligence-supported application provides access to a database without highly sensitive data, the risk score may be low; however, if an artificial-intelligence-supported application provides access to several databases with highly sensitive data, then the risk score may be high. Other variations and combinations of correlation scoring systems and risk scoring systems are contemplated for embodiments described herein.

The security posture management engine 120 is responsible for executing security queries and generating security posture visualizations. The security posture management engine 120 accesses a security query associated with the artificial intelligence security graph 116. The security posture management engine 120 executes the security query using the artificial intelligence security graph 116 and generates a first query result for the security query. The first query result comprises an artificial intelligence security alert. Using the first query result, the security posture management engine 120 generates the security posture visualization. The security posture visualization further includes an artificial intelligence security alert associated with an updated prioritization identifier and a remediation action. The updated prioritization identifier can generated using the artificial intelligence security graph and the remediation action can be executed to address a security threat associated with the artificial intelligence security alert.

A security management client 130 can communicate a request for the security posture of a computing environment. Based on the request, the security management client 130 receives a security posture visualization associated with the computing environment, where the security posture visualization comprises the artificial intelligence security alert that is associated with the artificial intelligence security graph 116. The security management client 130 causes display of the security posture visualization comprising the artificial intelligence security alert,

With reference to FIG. 2B, FIG. 2B illustrates a security management system 100A having artificial intelligence security engine 110, security management client 130, and security posture management engine 120. At block 10, the artificial intelligence security engine 110 accesses an artificial intelligence security graph generation model; at block 12, accesses application data associated with a plurality of artificial-intelligence-supported-applications; and at block 14, using the application data and the artificial intelligence security graph generation model, generates an artificial intelligence security graph; and at block 16, deploys the artificial intelligence security graph associated with analyzing artificial intelligence security alerts.

At block, 18 the security management client 130 communicates a request for the security posture of the computing environment. At block 20, the security posture management engine, accesses the request for the security posture of the computing environment; at block 22, accesses artificial intelligence attack monitoring data associated with an artificial intelligence security alert of an artificial-intelligence-supported-application; at block 24, based on the artificial intelligence attack monitoring data, the artificial intelligence security alert, and the artificial intelligence security graph, accesses operation data of an artificial-intelligence-supported application; at block 26, analyzes the artificial intelligence attack monitoring data and the operational data; at block 28, updates a prioritization identifier associated with the artificial intelligence security alert; and at block 30, communicates a security posture visualization comprising the artificial intelligence security alert with the updated prioritization identifier. At block 32, the security management client 130, based on the request, receives the security posture visualization associated with the computing environment; and at block 28, causes display of the security posture visualization comprising the artificial intelligence security alert associated with the updated prioritization identifier.

### Example Methods

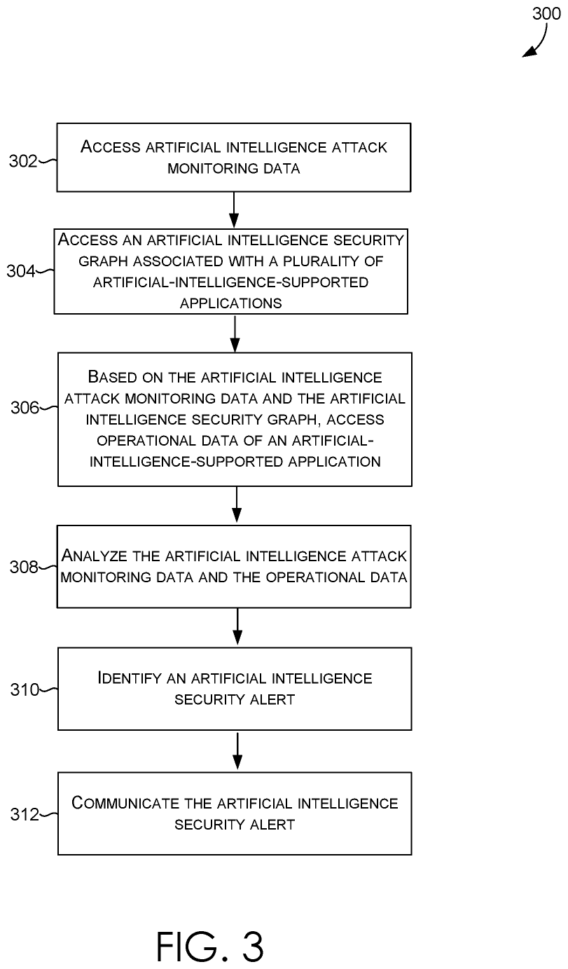

With reference to FIGS. 3, 4, and 5, flow diagrams are provided illustrating methods for providing security posture management using an artificial intelligence security engine in a security management system. The methods may be performed using the security management system described herein. In embodiments, one or more computer-storage media having computer-executable or computer-useable instructions embodied thereon that, when executed, by one or more processors can cause the one or more processors to perform the methods (e.g., computer-implemented method) in the security management system (e.g., a computerized system or computing system).

Turning to FIG. 3, a flow diagram is provided that illustrates a method 300 for providing security posture management using an artificial intelligence security engine in a security management system. At block 302, artificial intelligence attack monitoring data is accessed. At block 304, an artificial intelligence security associated with a plurality of artificial-intelligence-supported applications is accessed. At block 306, based on the artificial intelligence attack monitoring data and the artificial intelligence security graph, operational data of an artificial-intelligence-supported application is accessed. At block 308, the artificial intelligence attack monitoring data and the operational data are analyzed. At block 310, an artificial intelligence security alert is identified. At block 312, the artificial intelligence security alert is communicated.

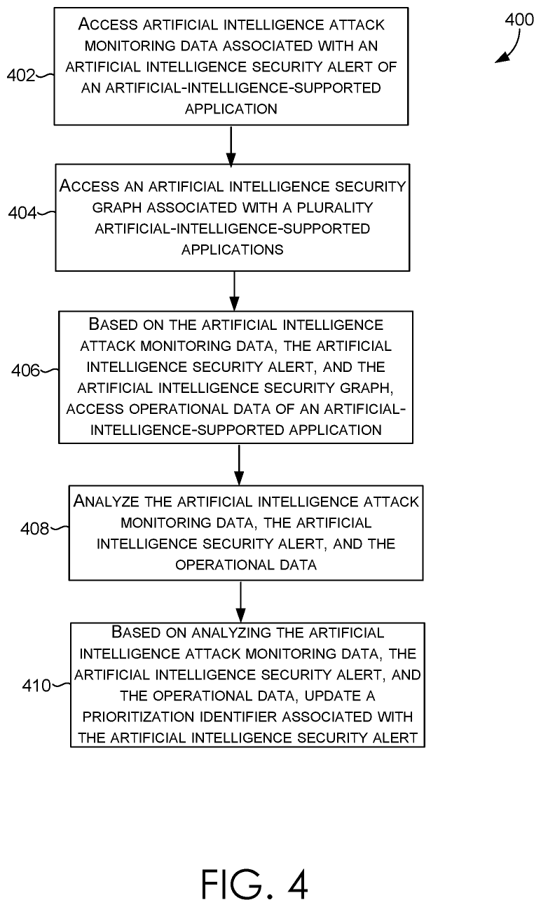

Turning to FIG. 4, a flow diagram is provided that illustrates a method 400 for providing security posture management using an artificial intelligence security engine in a security management system. At block 402, the artificial intelligence attack monitoring data associated with an artificial intelligence security alert of an artificial-intelligence-supported application is accessed. At block 404, an artificial intelligence security graph associated with a plurality artificial-intelligence-supported applications is accessed. At block 406, based on the artificial intelligence attack monitoring data, the artificial intelligence security alert and the artificial intelligence security graph, the operational data of an artificial-intelligence-supported application is accessed. At block 408, the artificial intelligence attack monitoring data, the artificial intelligence security alert, and the operational data is analyzed. At block 408, based on analyzing the artificial intelligence attack monitoring data, the artificial intelligence security alert, and the operational data, a prioritization identifier associated with the artificial intelligence security alert is updated.

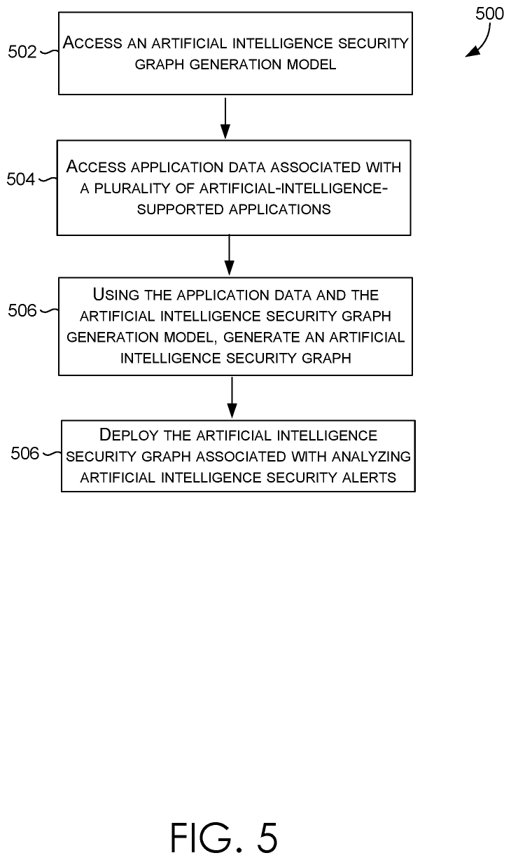

Turning to FIG. 5, a flow diagram is provided that illustrates a method 500 for providing security posture management using an artificial intelligence security engine in a security management system. At block 502, an artificial intelligence security graph generation model is accessed. At block 502, application data associated with plurality of artificial-intelligence-supported applications is accessed. At block 506, using the application data and the artificial intelligence security graph generation model, an artificial intelligence security graph is generated. At block 508, the artificial intelligence security graph associated with analyzing artificial intelligence security alerts is deployed.

### Technical Improvement

Embodiments of the present technical solution have been described with reference to several inventive features (e.g., operations, systems, engines, and components) associated with a security management system. Inventive features described include: operations, interfaces, data structures, and arrangements of computing resources associated with providing the functionality described herein relative with reference to an artificial intelligence security engine. Functionality of the embodiments of the present technical solution have further been described, by way of an implementation and anecdotal examples—to demonstrate that the operations (e.g., generating the artificial intelligence security graph and employing the artificial intelligence security graph to identify artificial intelligence security alerts based on artificial intelligence security engine operations) for providing the artificial intelligence security engine. The artificial intelligence security engine is as a solution to a specific problem (e.g., limitations in effective identification of artificial intelligence security alerts) in security management technology. The artificial intelligence security engine improves computing operations associated with security investigations and providing security posture information in security management systems. Overall, these improvements result in less CPU computation, smaller memory requirements, and increased flexibility in security management systems when compared to previous conventional security management system operations performed for similar functionality.

### Additional Support for Detailed Description

### Example Distributed Computing System Environment

Referring now to FIG. 6, FIG. 6 illustrates an example distributed computing environment 600 in which implementations of the present disclosure may be employed. In particular, FIG. 6 shows a high level architecture of an example cloud computing platform 610 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 600 that includes cloud computing platform 610, rack 620, and node 630 (e.g., computing devices, processing units, or blades) in rack 620. The technical solution environment can be implemented with cloud computing platform 610 that runs cloud services across different data centers and geographic regions. Cloud computing platform 610 can implement fabric controller 640 component for provisioning and managing resource allocation, deployment, upgrade, and management of cloud services. Typically, cloud computing platform 610 acts to store data or run service applications in a distributed manner. Cloud computing infrastructure 610 in a data center can be configured to host and support operation of endpoints of a particular service application. Cloud computing infrastructure 610 may be a public cloud, a private cloud, or a dedicated cloud.

Node 630 can be provisioned with host 650 (e.g., operating system or runtime environment) running a defined software stack on node 630. Node 630 can also be configured to perform specialized functionality (e.g., compute nodes or storage nodes) within cloud computing platform 610. Node 630 is allocated to run one or more portions of a service application of a tenant. A tenant can refer to a customer utilizing resources of cloud computing platform 610. Service application components of cloud computing platform 610 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 630, nodes 630 may be partitioned into virtual machines (e.g., virtual machine 652 and virtual machine 654). Physical machines can also concurrently run separate service applications. The virtual machines or physical machines can be configured as individualized computing environments that are supported by resources 660 (e.g., hardware resources and software resources) in cloud computing platform 610. It is contemplated that resources can be configured for specific service applications. Further, each service application may be divided into functional portions such that each functional portion is able to run on a separate virtual machine. In cloud computing platform 610, multiple servers may be used to run service applications and perform data storage operations in a cluster. In particular, the servers may perform data operations independently but exposed as a single device referred to as a cluster. Each server in the cluster can be implemented as a node.

Client device 680 may be linked to a service application in cloud computing platform 610. Client device 680 may be any type of computing device, which may correspond to computing device 600 described with reference to FIG. 6, for example, client device 680 can be configured to issue commands to cloud computing platform 610. In embodiments, client device 680 may communicate with service applications through a virtual Internet Protocol (IP) and load balancer or other means that direct communication requests to designated endpoints in cloud computing platform 610. The components of cloud computing platform 610 may communicate with each other over a network (not shown), which may include, without limitation, one or more local area networks (LANs) and/or wide area networks (WANs).

### Example Computing Environment

Having briefly described an overview of embodiments of the present technical solution, an example operating environment in which embodiments of the present technical solution may be implemented is described below in order to provide a general context for various aspects of the present technical solution. Referring initially to FIG. 6 in particular, an example operating environment for implementing embodiments of the present technical solution is shown and designated generally as computing device 600. Computing device 600 is but one example of a suitable computing environment and is not intended to suggest any limitation as to the scope of use or functionality of the technical solution. Neither should computing device 700 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing artificial intelligence attack monitoring data;
accessing an artificial intelligence security graph associated with a plurality of artificial-intelligence-supported applications of a computing environment;
based on the artificial intelligence attack monitoring data and the artificial intelligence security graph, accessing operational data of an artificial-intelligence-supported application;
analyzing the artificial intelligence attack monitoring data and the operational data;
based on analyzing the artificial intelligence attack monitoring data and the operational data, identifying an artificial intelligence security alert; and
communicating the artificial intelligence security alert.

2. The system of claim 1, wherein the artificial intelligence attack monitoring data comprises anomalous model input data or anomalous model output data from an interface of an artificial intelligence application associated one or more artificial-intelligence-supported applications in the computing environment.

3. The system of claim 1, wherein the operational data comprises security log data associated with the artificial-intelligence-supported application, wherein the operational data is identified based on nodes or edges of the artificial-intelligence-supported application in the artificial intelligence security graph.

4. The system of claim 1, wherein analyzing artificial intelligence attack monitoring data and the operational data comprises correlating artificial intelligence attack monitoring data and the operational data, wherein correlating artificial intelligence attack monitoring data and the operational data artificial intelligence security alert supports identifying the artificial intelligence security alert.

5. The system of claim 1, the operations further comprising generating a risk score that quantifies a likelihood or impact of a security threat associated with the artificial intelligence security alert, wherein the likelihood or the impact of the security threat is associated with a number of potential attack surfaces associated with the security threat.

6. The system of claim 1, the operations further comprising communicating a security posture visualization comprising the artificial intelligence security alert, wherein the artificial intelligence security alert is associated with a prioritization identifier and a risk score.

7. The system of claim 1, the operations further comprising:
receiving an indication to execute a remediation action associated with the artificial intelligence security alert, wherein the remediation action is associated a the security posture visualization; and
executing the remediation action.

8. The system of claim 1, the operations further comprising:
accessing the artificial intelligence attack monitoring data associated with the artificial intelligence security alert of the artificial-intelligence-supported application;
accessing the artificial intelligence security graph;
based on the artificial intelligence attack monitoring data, the artificial intelligence security alert, and the artificial intelligence security graph, accessing the operational data of the artificial-intelligence-supported application;
analyzing the artificial intelligence attack monitoring data, the artificial intelligence security alert, and the operational data; and
based on analyzing the artificial intelligence attack monitoring data, the artificial intelligence security alert, and the operational data, updating a prioritization identifier associated with the artificial intelligence security alert.

9. The system of claim 1, the operations further comprising:
receiving a request for the security posture of the computing environment;
generating a security posture visualization associated with the computing environment, wherein the security posture visualization comprises the artificial intelligence security alert; and
communicating the security posture visualization comprising the artificial intelligence security alert.

10. The system of claim 1, the operations further comprising:
based on the request, receiving the security posture visualization associated with the computing environment, wherein the security posture visualization comprises the artificial intelligence security alert; and
causing display of the security posture visualization comprising the artificial intelligence security alert.

11. One or more computer-storage media having computer-executable instructions embodied thereon that, when executed by a computing system having a processor and memory, cause the processor to perform operations, the operations comprising:
accessing artificial intelligence attack monitoring data associated with an artificial intelligence security alert of an artificial-intelligence-supported application;
accessing an artificial intelligence security graph associated with a plurality of artificial-intelligence-supported applications of a computing environment;
based on the artificial intelligence attack monitoring data, the artificial intelligence security alert, and the artificial intelligence security graph, accessing operational data of an artificial-intelligence-supported application;
analyzing the artificial intelligence attack monitoring data, the artificial intelligence security alert, and the operational data; and
based on analyzing the artificial intelligence attack monitoring data, the artificial intelligence security alert, and the operational data, updating a prioritization identifier associated with the artificial intelligence security alert.

12. The media of claim 11, wherein the artificial intelligence attack monitoring data comprises anomalous model input data or anomalous model output data from an interface of the artificial intelligence application associated with one or more artificial-intelligence-supported applications in the computing environment.

13. The media of claim 11, wherein analyzing artificial intelligence attack monitoring data, the artificial intelligence security alert, and the operational data comprises correlating artificial intelligence attack monitoring data, the artificial intelligence security alert, the operational data, wherein correlating artificial intelligence attack monitoring data, the artificial intelligence security alert, and the operational data artificial intelligence security alert supports updating the prioritization identifier.

14. The media of claim 11, the operations further comprising:
receiving a request for the security posture of the computing environment;
generating a security posture visualization associated with the computing environment, wherein the security posture visualization comprises the artificial intelligence security alert and the updated prioritization identifier;
communicating the security posture visualization comprising the artificial intelligence security alert and the updated prioritization identifier.

15. The media of claim 11, the operations further comprising:
receiving an indication to execute a remediation action associated with the artificial intelligence security alert, wherein the remediation action is associated with the security posture visualization; and
executing the remediation action.

16. A computer-implemented method, the method comprising:
accessing an artificial intelligence security graph generation model, the artificial intelligence security graph generation model comprises instructions on how to generate an artificial intelligence security graph;
accessing application data associated with a plurality of artificial-intelligence-supported applications of a computing environment;
using the application data and the artificial intelligence security graph generation model, generating the artificial intelligence security graph of the plurality of artificial-intelligence-supported applications; and
deploying the artificial intelligence security graph associated with analyzing artificial intelligence security alerts.

17. The method of claim 16, wherein the artificial intelligence security graph generation model is a model of the plurality of artificial-intelligence-supported applications and their connections in the computing environment.

18. The method of claim 16, wherein generating the artificial intelligence security graph comprises:
generating a first layer of the artificial intelligence security graph based on a first set of application data from the application data, wherein the first set of application data comprises account-based connections between an artificial-intelligence-supported application and an artificial intelligence application;
generating a second layer of the artificial intelligence security graph based on a second set of application data from the application data, wherein the second set application data comprises configuration-based connections between the artificial-intelligence-supported application and an artificial intelligence application; and
generating a third layer of artificial intelligence security graph based on a third set of application data from the application data, wherein the third set of application data comprises code-based connections between the artificial-intelligence-supported application and an artificial intelligence application.

19. The method of claim 16, the method further comprising:
accessing artificial intelligence attack monitoring data;
accessing the artificial intelligence security graph;
based on the artificial intelligence attack monitoring data and the artificial intelligence security graph, accessing operational data of an artificial-intelligence-supported application;
analyzing the artificial intelligence attack monitoring data and the operational data;
based on analyzing the artificial intelligence attack monitoring data and the operational data, identifying an artificial intelligence security alert; and
communicating the artificial intelligence security alert.

20. The method of claim 16, the method further comprising:
accessing artificial intelligence attack monitoring data associated with an artificial intelligence security alert of an artificial-intelligence-supported application;
accessing the artificial intelligence security graph;
based on the artificial intelligence attack monitoring data, the artificial intelligence security alert, and the artificial intelligence security graph, accessing operational data of an artificial-intelligence-supported application;
analyzing the artificial intelligence attack monitoring data, the artificial intelligence security alert, and the operational data; and
based on analyzing the artificial intelligence attack monitoring data, the artificial intelligence security alert, and the operational data, updating a prioritization identifier associated with the artificial intelligence security alert.
